(19) United States
(12) Patent Application Publication
(10) Pub. No.: US 2019/0273292 A1
(43) Pub. Date: Sep. 5, 2019

(54) BATTERY PACK COMPRISING A PLURALITY OF BATTERY MODULES

(71) Applicant: VARTA Microbattery GmbH, Ellwangen Jagst (DE)

(72) Inventors: Stefan Hald, Ellwangen (DE); Dieter Kloos, Fichtenau (DE)

(21) Appl. No.: 16/292,785

(22) Filed: Mar. 5, 2019

(30) Foreign Application Priority Data
Mar. 5, 2018 (EP) 18159880.6

(51) Int. Cl. H01M 10/613; H01M 10/653; H01M 10/658; H01M 2/14; H01M 10/48

(52) U.S. Cl. CPC H01M 10/613; H01M 10/653; H01M 10/486; H01M 2/14; H01M 10/658

(57) ABSTRACT

A battery pack having a plurality of battery modules includes: a. a spacer arranged between the battery modules, b. the spacer includes a first cooling element composed of a first thermally conductive material, which first cooling element is in surface-to-surface contact with a first of the battery modules, c. the spacer includes a second cooling element composed of a second thermally conductive material, which second cooling element is in surface-to-surface contact with a second of the battery modules, d. the spacer includes an intermediate space between the cooling elements, which intermediate space is at least partially filled with an insulating material, and e. the insulating material has a lower thermal conductivity than the first and than the second thermally conductive material so that heating of the first battery module does not result in heating of the second battery module or does so only with a delay.

### TECHNICAL FIELD

This disclosure below relates to a battery pack having a plurality of battery modules.

### BACKGROUND

The term “battery pack” is interpreted very broadly, specifically as an arrangement of a plurality of battery modules that can thermally influence one another. The battery pack can comprise a case or a housing in which the battery modules are arranged in an assembly, but does not have to. Such battery packs comprising a plurality of battery modules can be used both in stationary systems, for example, the battery cabinet described in DE 102012209744 A1, and also in mobile systems, for example, as a constituent part of a motor vehicle battery. The battery modules may be individual electrochemical cells (individual cells) or assemblies comprising two or more cells of this kind. The individual cells can in turn be connected to one another by parallel and/or serial interconnection within an assembly of this kind.

There is thus a need to provide battery packs that are as compact as possible, namely to arrange as many battery modules as possible in as small an area as possible.

Since battery modules already exhibit considerable heat output even during normal operation, battery packs often have to be cooled. When a battery module enters an irregular state, for example, as a result of excessive charging or mechanical damage, it can become very hot. If the battery module is a constituent part of a battery pack, this necessarily leads to transfer of heat to adjacent battery modules that can likewise be converted into an irregular state as a result of the heating. This effect is known by the term “propagation.”

Spacers for battery packs are known, wherein such spacers physically separate the individual battery modules from one another. For example, US 2016/0172642 A1 discloses a spacer of triangular design arranged between a cell group comprising three cylindrical battery modules. The spacer is composed of an electrically insulating material that can possibly also counteract propagation. However, since the spacer completely fills the intermediate space between the three cylindrical battery modules, it also impedes possible convection and therefore cooling of the battery modules.

EP 2 615 661 A1 discloses a spacer having a rectangular frame in which receiving parts for battery modules are arranged. The spacer is preferably manufactured from plastic and therefore likewise appears to counteract possible propagation. Cooling of the battery modules can be performed by channels in the spacer, it being possible for sensors to detect the temperature of the battery modules to also be arranged in the channels if desired.

A further spacer composed of a plastic is known in EP 2 375 471 A2. The combined use of the spacer with a temperature sensor is also described.

### SUMMARY

We provide a battery pack having a plurality of battery modules including: a. a spacer arranged between the battery modules, b. the spacer includes a first cooling element composed of a first thermally conductive material, which first cooling element is in surface-to-surface contact with a first of the battery modules, c. the spacer includes a second cooling element composed of a second thermally conductive material, which second cooling element is in surface-to-surface contact with a second of the battery modules, d. the spacer includes an intermediate space between the cooling elements, which intermediate space is at least partially filled with an insulating material, and e. the insulating material has a lower thermal conductivity than the first and than the second thermally conductive material so that heating of the first battery module does not result in heating of the second battery module or does so only with a delay.

### BRIEF DESCRIPTION OF THE DRAWINGS

FIG. 1 schematically shows a frontal plan view, from the front, of an example of a battery pack including a plurality of battery modules together with a spacer arranged between the battery modules.

FIG. 2 schematically shows a plan view, obliquely from above, of the rear side of the spacer illustrated in FIG. 1 together with one of the battery modules.

FIG. 3 schematically shows a cross section through the spacer illustrated in FIG. 2 (section through line A in FIG. 2).

### DETAILED DESCRIPTION

Our battery pack has, like battery packs of the generic type, a plurality of battery modules. However, in contrast to the generic battery packs, our battery pack is distinguished by a combination of the following features:

the battery pack comprises a spacer arranged between the battery modules;

the spacer comprises a first cooling element composed of a first thermally conductive material, which first cooling element is in surface-to-surface contact with a first of the battery modules;

the spacer comprise a second cooling element composed of a second thermally conductive material, which second cooling element is in surface-to-surface contact with a second of the battery modules;

the space comprises an intermediate space between the cooling elements, which intermediate space is at least partially filled with an insulating material; and

the insulating material has a lower thermal conductivity than the first and second thermally conductive material so that heating of the first battery module does not result in heating of the second battery module or does so only with a delay.

the insulating material has a lower thermal conductivity than the first and second thermally conductive material so that heating of the first battery module does not result in heating of the second battery module or does so only with a delay.

The spacer of our battery pack has major advantages over known spacers. The cooling elements ensure that the battery modules that are in surface-to-surface contact can be cooled. Surface-to-surface contact is intended to be understood to mean direct contact extending between the cooling elements and the battery modules over a two-dimensional contact area. This is preferably achieved by the surfaces by which the cooling elements and the battery modules are in direct contact with one another being geometrically matched to one another. The insulating material arranged in the intermediate space at the same time ensures that heat cannot be transmitted without obstruction from one battery module to the next battery module. The spacer therefore counteracts the heat propagation described above.

The battery pack can comprise a spacer comprising only the first and the second cooling element. For example, the two cooling elements can each comprise a layered region, between which regions the, likewise layered, intermediate space is formed between the cooling elements, which intermediate space is at least partially filled with the insulating material. These regions are then preferably arranged between two battery modules, wherein each of the regions is in surface-to-surface contact with one of the battery modules. A specific application in this respect would be, for example, if the battery pack is designed as a stack comprising two or more individual cells of layered design, wherein each of the stacked cells are separated from one another by the spacer.

However, this disclosure is not limited to examples comprising only the first and the second cooling element. Particular preference is given to examples with two to five cooling elements, in particular with three or four cooling elements, very particularly preferably with three cooling elements that are each in surface-to-surface contact with a battery module of the battery pack.

Accordingly, in a first, particularly preferred example with precisely three cooling elements, the battery pack has the following additional features:

the spacer comprises a third cooling element composed of a third thermally conductive material, which third cooling element is in surface-to-surface contact with a third of the battery modules;

the spacer comprises an intermediate space between the three cooling elements, which intermediate space is at least partially filled with the insulating material; and

the insulating material has a lower thermal conductivity than the third thermally conductive material so that heating of the third battery module does not result in heating of the first and/or the second battery module or does so only with a delay.

In a second, particularly preferred example with precisely four cooling elements, the battery pack has the following additional features:

the spacer comprises a third cooling element composed of a third thermally conductive material, which third cooling element is in surface-to-surface contact with a third of the battery modules, and a fourth cooling element composed of a fourth thermally conductive material, which fourth cooling element is in surface-to-surface contact with a fourth of the battery modules;

the spacer comprises an intermediate space between the four cooling elements, which intermediate space is at least partially filled with the insulating material; and

the insulating material has a lower thermal conductivity than the third and the fourth thermally conductive material so that heating of the third battery module does not result in heating of the first and/or the second and/or the fourth battery module or does so only with a delay, and heating of the fourth battery module does not result in heating of the first and/or the second and/or the third battery module or does so only with a delay.

The spacer creates a physical distance between the battery modules of the battery pack. The spacer is particularly preferably of symmetrical, in particular rotationally symmetrical, design. In examples with three or more cooling elements, the spacer is preferably designed such that all battery modules in contact with the cooling elements have the same orientation and are at the same distance from one another. The spacer can be present as a separate component inserted between the battery modules of the battery pack to provide the battery pack. However, the spacer can also be a constituent part of an apparatus in which the battery pack is arranged, for example, the housing of a battery cabinet.

In a first preferred configuration, the battery pack has at least one of the following features:

the first and the second thermally conductive material are identical;

the first and the second and the third thermally conductive material are identical; or the first and the second and the third and the fourth thermally conductive material are identical;

and also at least one further one, preferably all, of the following features:

the insulating material is a plastic or a plastic-based material;

the insulating material is arranged in the intermediate space in the form of a supporting element to which the first and the second cooling element and also possibly the third and/or the fourth cooling element are fixed, the cooling elements are connected to one another by at least one connecting element composed of a fifth material; and the fifth material is identical to the first and the second thermally conductive material, possibly also to the third and/or the fourth thermally conductive material.

In a second preferred configuration, the battery pack has at least one of the following features:

the first and the second thermally conductive material are identical;

the first and the second and the third thermally conductive material are identical; or

the first and the second and the third and the fourth thermally conductive material are identical;

and also at least one further one, preferably all, of the following features:

the insulating material is air;

the cooling elements connect to one another by at least one connecting element composed of a fifth material; and

the fifth material is identical to the first and the second thermally conductive material, possibly also to the third and/or fourth thermally conductive material.

Whereas the spacer according to the first configuration has a high degree of structural integrity, the spacer according to the second configuration is particularly distinguished in that the cooling elements can be cooled extremely well by an air stream guided through the intermediate space.

In the first configuration, the supporting element can completely fill the intermediate space between the cooling elements. The supporting element then preferably has receptacles for the cooling elements on its surface. However, the supporting element can also be of multi-member design and have one member, to or in which it is fixed, for each of the cooling elements.

The insulating material is particularly preferably a plastic, for example, a polycarbonate (PC) or an acrylonitrile butadiene styrene (ABS), or a plastic-based material, that is to say, for example, one of the mentioned plastics admixed with a filler.

The filler may also be a phase change material, that is to say a material of which the latent heat of fusion, heat of dissolution or heat of absorption is greater than the heat that it could store on the basis of its specific heat capacity.

In a further particularly preferred example, the insulating material can be a foam, that is to say a foamed plastic, for example, a polyurethane foam or expanded polystyrene (also known as Styropor).

In the second configuration, the at least one connecting element generally has to ensure the structural integrity of the spacer.

In both configurations, it is preferred, in principle, for all cooling elements to be formed from the same thermally conductive material. However, in individual examples, it may also be preferred to form cooling elements within one and the same battery pack from different thermally conductive materials. This may be advantageous, for example, when battery modules within the battery pack have to be cooled to different degrees depending on their position. Therefore, battery modules arranged in a battery pack toward the outside generally require less cooling than battery modules which are arranged in the center of a battery pack.

In the second configuration, it is further preferred that all cooling elements and the connecting element are formed from the same thermally conductive material. All cooling elements and the connecting element are preferably a constituent part of one and the same component which is of integral design.

It is preferred for the battery pack to be distinguished by at least one, preferably by all, of the following additional features:

the first and/or the second and/or the third and/or the fourth thermally conductive material and/or the fifth material have/has a thermal conductivity which exceeds the thermal conductivity of the insulating material at least by a factor of 10, preferably at least by a factor of 100;

the first and/or the second and/or the third and/or the fourth thermally conductive material and/or the fifth material are/is a metal or a metal alloy, particularly preferably from the group comprising iron, copper, aluminium and alloys of these elements; and

the first and/or the second and/or the third and/or the fourth thermally conductive material and/or the fifth material are/is a plastic filled with a solid having a thermal conductivity ≥10 W/(m*K), particularly preferably having a thermal conductivity ≥100 W/(m*K), for example, graphite or graphene.

The thermal conductivity of the thermally conductive materials particularly preferably is 15 to 500 W/(m·k), particularly preferably 20 to 450 W/(m·k) and very particularly preferably 90 to 400 W/(m·k). The thermal conductivity of the insulating material preferably is 0.01 to 1 W/(m·k), particularly preferably 0.1 to 0.8 W/(m·k) and very particularly preferably 0.2 to 0.6 W/(m·k).

The thermal conductivity is a material property or material constant that determines the flow of heat through a material on the basis of the thermal conduction. The thermal conductivity is typically specified as a specific thermal conductivity of material in the abovementioned unit watts per meter-kelvin W/(m*k). The thermal conductivity of the majority of the materials rises slightly as the temperature rises. The above numerical values relate to thermal conductivities at 20° C.

It is particularly preferred for the battery pack to have at least one, preferably all, of the following additional features:

the battery modules are of elongate design and each have an axis of main extent between two longitudinal ends;

the axes of main extent of the first and the second battery module and also possibly the third battery module and/or the fourth battery module run parallel in relation to one another;

the spacer is an elongate shaped body and has an axis of main extent between two longitudinal ends, which axis of main extent runs parallel in relation to the axes of main extent of the first and the second battery module;

the first and/or the second and/or the third and/or the fourth cooling element are/is of elongate design, in particular designed as a strip;

the first elongate cooling element is oriented parallel in relation to the axis of main extent of the first battery module;

the second elongate cooling element is oriented parallel in relation to the axis of main extent of the second battery module;

the third elongate cooling element may be oriented parallel in relation to the axis of main extent of the third battery module; and

the fourth elongate cooling element may be oriented parallel in relation to the axis of main extent of the fourth battery module.

Our battery module or a spacer or a cooling element is elongate when the distance between the two longitudinal ends exceeds its maximum diameter at least by a factor of 2. Therefore, the axis of main extent is preferably a longitudinal axis.

The battery modules are particularly preferably designed as cylinders and have a height exceeding the cylinder diameter at least by a factor of 2, preferably at least by a factor of 4. In these examples, the longitudinal ends are formed by the two end sides of the cylinder. In this example, the axis of main extent is the cylinder axis. In this example, the cylindrical battery modules are preferably oriented parallel in relation to one another.

The spacer can have the same length as the battery modules. However, it can also be shorter or longer.

The length of the cooling elements is limited by the length of the spacer.

In a preferred example of the battery pack, it has at least one, preferably all, of the following additional features:

the spacer comprises a coupling device that couples a cooling device to the spacer;

a first coupling device is located at one of the longitudinal ends of the spacer;

a second coupling device is located at one of the longitudinal ends of the spacer;

the first and/or the second coupling device comprise/comprises or are/is a receptacle for the cooling device or for a connecting piece to the cooling device, in particular a bore with an internal thread;

the first and the second coupling device connect to one another by a channel guided through the spacer;

the spacer comprises, as connecting element, a first connecting element comprising the first coupling device;

the spacer comprises, as a connecting element, a second connecting element comprising the second coupling device;

the first and/or the second connecting element form the longitudinal ends/forms one of the longitudinal ends of the spacer or are arranged at the longitudinal ends/is arranged at one of the longitudinal ends of the spacer; and

the first and/or the second connecting element form/forms a thermally conductive path between the cooling elements and the cooling device.

The cooling device conducts heat out of the intermediate space of the battery modules. A possible cooling device can be, for example, a passive heat sink that increases the size of the surface of the battery modules giving off heat. However, it is also possible for the coupling device to comprise a connection for a cooling circuit in which air or any other cooling medium is introduced into the spacer for cooling purposes.

This may be preferred, in particular, when a coupling device (the first and the second coupling device) is located at the two ends of the spacer, which two ends connect to one another by the channel which is guided through the spacer. In this example, the cooling medium can be introduced into the spacer by one of the coupling devices and can be conducted out of the spacer by the other coupling device.

The first and the second connecting element are preferably thermally conductively connected to one another. Therefore, in the same way as the first and/or the second connecting element form/forms a thermally conductive path between the cooling elements and the cooling device, the cooling elements can also form a thermally conductive path between the connecting elements.

In a particularly preferred example, the battery pack has at least one, preferably all, of the following features:

the spacer comprises the first, the second and the third cooling element that are each composed of one of the thermally conductive materials and are in surface-to-surface contact with one of the battery modules;

the spacer and the battery modules are each elongated and each have an axis of main extent between two longitudinal ends;

the spacer comprises the supporting element composed of the insulating material on which supporting element the first and the second and the third cooling element are fixed and which supporting element fills the intermediate space between these three cooling elements;

the cooling elements are strips on the surface of the supporting element and arranged parallel in relation to one another and are also parallel in relation to the axes of main extent of the battery modules and the spacer;

the spacer comprises, as connecting element, a first connecting element composed of one of the thermally conductive materials, which first connecting element connects the three cooling elements;

the first connecting element forms the first of the longitudinal ends of the spacer;

the spacer comprises, as connecting element, a second connecting element composed of one of the thermally conductive materials, which second connecting element connects the three cooling elements;

the second connecting element forms the second of the longitudinal ends of the spacer;

the supporting element is arranged between the first and the second connecting element; and

the first and the second connecting element each connect the three cooling elements to one another.

In this preferred example, the three cooling elements and the connecting elements are generally composed of an identical material, for example, a metal or a metal alloy.

In a preferred configuration, the battery pack has one of the following features:

the battery modules of the battery pack each have a bent or non-bent contact region by which they are in surface-to-surface contact with the cooling elements;

the battery modules have a cylindrical casing, the surface of which comprises the contact region;

the cooling elements each have a contact region matched to the geometry of the contact region of the battery modules; or the cooling elements each have an elongate recess with a concave cross section.

In a further, particularly preferred configuration, the battery pack has at least one, preferably all, of the following features:

the spacer comprises a first temperature sensor in thermal contact with the first cooling element and a second temperature sensor in thermal contact with the second cooling element and also possibly a third and/or a fourth temperature sensor in thermal contact with the third and/or the fourth cooling element;

the temperature sensors connect to the cooling elements directly or by a thermal conductor; and

the temperature sensors are embedded into the cooling elements or into recesses in the contact regions of the cooling elements.

Since each of the cooling elements has its own associated temperature sensor and the cooling elements are insulated from one another by the insulating material, it is ensured that the temperature sensors are influenced to a greater extent by the heat of the battery module in question than by the heat of an adjacent battery module. The temperature sensors preferably connect to a corresponding regulation and control unit by cables. These cables can be guided, for example, through the supporting element to a longitudinal end of the spacer.

Further features, details and preferences can be found in the appended claims and the abstract, the wording of both of which being incorporated in the content of the description by express reference, the following description of preferred examples and also with reference to the drawings.

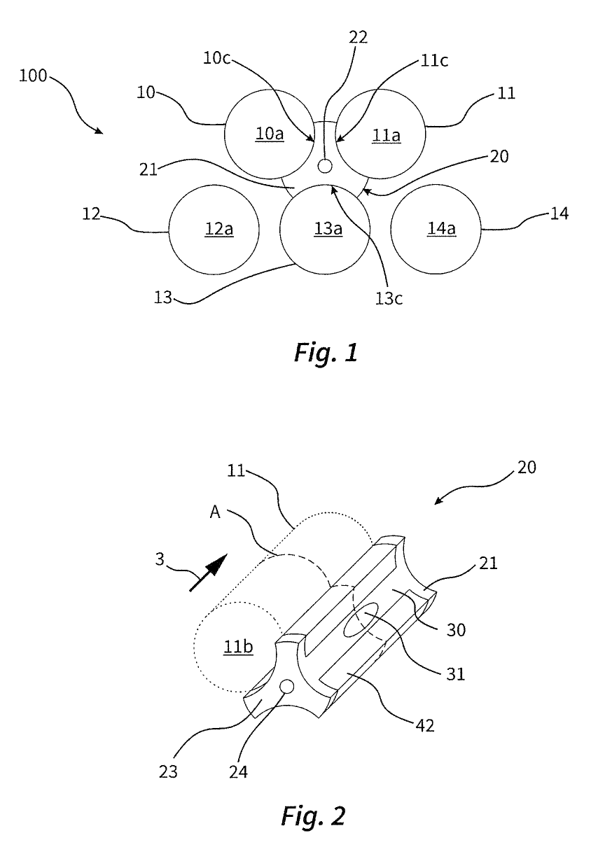

The battery pack 100 illustrated in FIG. 1 comprises a plurality of battery modules 10, 11, 12, 13 and 14 and a spacer 20 in surface-to-surface contact with three of the battery modules 10, 11 and 13.

The spacer 20 has, as a first longitudinal end, an end-side connecting element 21, the function of which will become clear in FIG. 2. The connecting element 21 comprises, as coupling device 22, a bore with an internal thread, not illustrated. This coupling device 22 can connect a cooler device to the spacer 20.

In this example, the battery modules 10, 11, 12, 13 and 14 are of cylindrical design and each have, as axis of main extent, a cylinder axis between two longitudinal ends. The three battery modules 10, 11 and 13 are in surface-to-surface contact with the spacer 20 and arranged in a triangular arrangement in which they are each at an equal distance from one another. The end sides 10a, 11a, 12a, 13a and 14a facing frontally towards the front, each form a longitudinal end of the respective battery module. The battery modules and therefore also their axes of main extent are all oriented parallel in relation to one another.

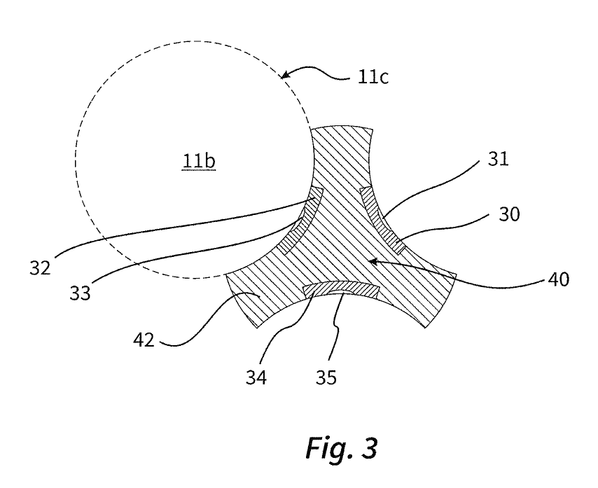

It is clear with reference to FIGS. 2 and 3 that the illustrated spacer 20 is of rotationally symmetrical design. For reasons of clarity, the battery modules have not been illustrated in the illustration of the spacer 20. The battery module 11 is merely illustrated using dashed lines.

The spacer 20 comprises a first cooling element 30 designed as an elongate strip with a constant width. The second and the third cooling element 32 and 34, which are not shown here, both have the same shape, size and orientation. All cooling elements 30, 32 and 34 are composed of a highly thermally conductive metal.

However, the cooling elements 30, 32 and 34 are not in direct contact with one another. Instead, the spacer 20 comprises the supporting element 42 that completely fills the intermediate space 40 between the three cooling elements. The support element is composed of a poorly thermally conductive plastic serving as insulating material and thermally isolates the cooling elements 30, 32 and 34 from one another.

The three cooling elements 30, 32 and 34 are fixed to the supporting element 42. The three cooling elements are oriented parallel in relation to one another and also parallel in relation to the axes of main extent of the battery modules 10, 11 and 13 and the spacer 20 in the battery pack 10. The spacer 20 comprises, as connecting elements, a first connecting element 21 and a second connecting element 23. The two connecting elements 21 and 23 are composed of the metal from which the three cooling elements 30, 32 and 34 are also composed. In the illustrated example, the first, the second and the third cooling element 30, 32 and 34 and the connecting elements 21 and 23 are combined to form a common component. The connecting elements 21 and 23 delimit the cooling elements in the axial direction.

The two connecting elements 21 and 23 form the longitudinal ends of the spacer 20, the supporting element 42 being incorporated between the longitudinal ends. The connecting elements 21 and 23 form, in principle, a thermally conductive path between the cooling elements 30, 32 and 34. On the other side, the connecting elements 21 and 23 can, as already mentioned, be cooled by the coupling devices 22 and 24.

The cooling elements 30, 32 and 34 are each designed for surface-to-surface contact with the lateral surfaces 10c, 11c and 13c of the respectively associated battery module.

It is possible to connect the connecting elements 21 and 23 to one another by a channel (not shown) guided through the spacer 20. In this example, a cooling medium can, for example, be introduced into the spacer 20 by the coupling device 22 and conducted out of the spacer 20 by the coupling device 24.

In the illustrated example, the connecting element 21 protrudes beyond the longitudinal ends of the battery modules. However, a variant of the spacer 20 in which the longitudinal ends of the spacer 20 terminate flush with the longitudinal ends of the battery module 10 is also possible.

The spacer 20 comprises a first temperature sensor 31 in thermal contact with the first cooling element 30, and a second temperature sensor 33 in thermal contact with the second cooling element 32, and also a third temperature sensor 35 in thermal contact with the third cooling element 34. The cooling elements 30, 32 and 34 each comprise a recess, in which recesses the temperature sensors 31, 33 and 35 are arranged.

1. A battery pack having a plurality of battery modules comprising:
a. a spacer arranged between the battery modules,
b. the spacer comprises a first cooling element composed of a first thermally conductive material, which first cooling element is in surface-to-surface contact with a first of the battery modules,
c. the spacer comprises a second cooling element composed of a second thermally conductive material, which second cooling element is in surface-to-surface contact with a second of the battery modules,
d. the spacer comprises an intermediate space between the cooling elements, which intermediate space is at least partially filled with an insulating material, and
e. the insulating material has a lower thermal conductivity than the first and than the second thermally conductive material so that heating of the first battery module does not result in heating of the second battery module or does so only with a delay.

2. The battery pack according to claim 1, further comprising:
a. the spacer comprises a third cooling element composed of a third thermally conductive material, which third cooling element is in surface-to-surface contact with a third of the battery modules,
b. the spacer comprises an intermediate space between the three cooling elements, which intermediate space is at least partially filled with the insulating material, and
c. the insulating material has a lower thermal conductivity than the third thermally conductive material so that heating of the third battery module does not result in heating of the first and/or the second battery module or does so only with a delay.

3. The battery pack according to claim 1, further comprising:
a. the spacer comprises a third cooling element composed of a third thermally conductive material, which third cooling element is in surface-to-surface contact with a third of the battery modules, and a fourth cooling element composed of a fourth thermally conductive material, which fourth cooling element is in surface-to-surface contact with a fourth of the battery modules;
b the spacer comprises an intermediate space between the four cooling elements, which intermediate space is at least partially filled with the insulating material; and
c. the insulating material has a lower thermal conductivity than the third and the fourth thermally conductive material so that heating of the third battery module does not result in heating of the first and/or the second and/or the fourth battery module or does so only with a delay, and heating of the fourth battery module does not result in heating of the first and/or the second and/or the third battery module or does so only with a delay.

4. The battery pack according to claim 1, further comprising at least one of:
a. the first and the second thermally conductive material are identical;
b. the first and the second and the third thermally conductive material are identical;
c. the first and the second and the third and the fourth thermally conductive material are identical;
d. the insulating material is a plastic or a plastic-based material;
e. the insulating material is arranged in the intermediate space in the form of a supporting element to which the first and the second cooling element and optionally the third cooling element and/or the fourth cooling element are/is fixed;
f. the cooling elements connect to one another by at least one connecting element (21) composed of a fifth material; and
g. the fifth material is identical to the first and the second thermally conductive material, possibly also to the third and/or the fourth thermally conductive material.

5. The battery pack according to claim 1, further comprising at least one of:
a. the first and the second thermally conductive material are identical;
b. the first and the second and the third thermally conductive material are identical;
c. the first and the second and the third and the fourth thermally conductive material are identical;
d. the insulating material is air;
e. the cooling elements connect to one another by at least one connecting element composed of a fifth material; and
f. the fifth material is identical to the first and the second thermally conductive material, optionally also to the third and/or fourth thermally conductive material.

6. The battery pack according to claim 1, further comprising at least one of:
a. the first and/or the second and/or the third and/or the fourth thermally conductive material and/or the fifth material have/has a thermal conductivity which exceeds the thermal conductivity of the insulating material at least by a factor of 10;
b. the first and/or the second and/or the third and/or the fourth thermally conductive material and/or the fifth material are/is a metal or a metal alloy; and
c. the first and/or the second and/or the third and/or the fourth thermally conductive material and/or the fifth material are/is a plastic filled with a solid having a thermal conductivity ≥10 W/(m*K).

7. The battery pack according to claim 1, further comprising at least one of:
a. the battery modules are elongated and each have an axis of main extent between two longitudinal ends;
b. the axes of main extent of the first and the second battery module and optionally the third battery module and/or the fourth battery module run parallel in relation to one another;
c. the spacer is an elongated shaped body and has an axis of main extent between two longitudinal ends, which axis of main extent runs parallel in relation to the axes of main extent of the first and the second battery module;
d. the first and/or the second cooling element and/or the third cooling element and/or the fourth cooling element are/is elongated as a strip;
e. the first elongate cooling element is oriented parallel in relation to the axis of main extent of the first battery module;
f. the second elongate cooling element is oriented parallel in relation to the axis of main extent of the second battery module;
g. the third elongate cooling element may be oriented parallel in relation to the axis of main extent of the third battery module; and
h. the fourth elongate cooling element may be oriented parallel in relation to the axis of main extent of the fourth battery module.

8. The battery pack according to claim 1, further comprising at least one of:
a. the spacer comprises a coupling device for coupling a cooling device to the spacer;
b. a first coupling device is located at one of the longitudinal ends of the spacer;
c. a second coupling device is located at one of the longitudinal ends of the spacer;
d. the first and/or the second coupling device comprise/comprises or are/is a receptacle for the cooling device or a connecting piece to the cooling device or a bore with an internal thread;
e. the first and the second coupling device connect to one another by a channel guided through the spacer;
f. the spacer comprises, as connecting element, a first connecting element comprising the first coupling device;
g. the spacer comprises, as connecting element, a second connecting element comprising the second coupling device;
h. the first and/or the second connecting element form the longitudinal ends/forms one of the longitudinal ends of the spacer or are arranged at the longitudinal ends/is arranged at one of the longitudinal ends of the spacer; and
i. the first and/or the second connecting element form/forms a thermally conductive path between the cooling elements and the cooling device.

9. The battery pack according to claim 1, further comprising the following additional features:
a. the spacer comprises the first, the second and the third cooling element, each composed of one of the thermally conductive materials and in surface-to-surface contact with one of the battery modules;
b. the spacer and the battery modules are each elongated and each have an axis of main extent between two longitudinal ends;
c. the spacer comprises the supporting element composed of the insulating material, on which supporting element the first and the second and the third cooling element are fixed and which supporting element fills the intermediate space between these three cooling elements;
d. the cooling elements are strips on the surface of the supporting element and are arranged parallel in relation to one another and also parallel in relation to the axes of main extent of the battery modules and the spacer;
e. the spacer comprises, as connecting element, a first connecting element composed of one of the thermally conductive materials, which first connecting element connects the three cooling elements;
f. the first connecting element forms the first of the longitudinal ends of the spacer;
g. the spacer comprises, as connecting element, a second connecting element composed of one of the thermally conductive materials, which second connecting element connects the three cooling elements;
h. the second connecting element forms the second of the longitudinal ends of the spacer;
i. the supporting element is arranged between the first connecting element and the second connecting element; and
j. the first connecting element and the second connecting element each connect the three cooling elements to one another.

10. The battery pack according to claim 9, further comprising:
a. the battery modules of the battery pack each have a bent or non-bent contact region by which they are in surface-to-surface contact with the cooling elements;
b. the battery modules have a cylindrical casing, the surface of which comprises the contact region;
c. the cooling elements each have a contact region matched to the geometry of the contact region of the battery modules; and
d. the cooling elements each have an elongate recess with a concave cross section.

11. The battery pack according to claim 1, further comprising at least one of:
a. the spacer comprises a first temperature sensor in thermal contact with the first cooling element and a second temperature sensor in thermal contact with the second cooling element and optionally a third temperature sensor and/or a fourth temperature sensor in thermal contact with the third cooling element and/or the fourth cooling element;
b. the temperature sensors connect to the cooling elements directly or by a thermal conductor; and
c. the temperature sensors are embedded into the cooling elements or into recesses in the contact regions of the cooling elements.
